(19) United States
(12) Patent Application Publication
(10) Pub. No.: US 2013/0238877 A1
(43) Pub. Date: Sep. 12, 2013

(54) CORE SYSTEM FOR PROCESSING AN INTERRUPT AND METHOD FOR TRANSMISSION OF VECTOR REGISTER FILE DATA THEREFOR

(71) Applicants: Jin-Seok Lee, Seoul (KR); Dong-Hoon Yoo, Seongnam-si (KR); Won-Sub Kim, Anyang-si (KR); Tai-Song Jin, Seoul (KR); Hae-Woo Park, Seoul (KR); Min-Wook Ahn, Seoul (KR); Hee-Jin Ahn, Seoul (KR)

(72) Inventors: Jin-Seok Lee, Seoul (KR); Dong-Hoon Yoo, Seongnam-si (KR); Won-Sub Kim, Anyang-si (KR); Tai-Song Jin, Seoul (KR); Hae-Woo Park, Seoul (KR); Min-Wook Ahn, Seoul (KR); Hee-Jin Ahn, Seoul (KR)

(73) Assignee: SAMSUNG ELECTRONICS CO., LTD., Suwon-si (KR)

(21) Appl. No.: 13/672,756

(22) Filed: Nov. 9, 2012

(30) Foreign Application Priority Data
Nov. 10, 2011 (KR) 10-2011-0117186

(51) Int. Cl. G06F 15/76

(52) U.S. Cl. 712/4; 712/E09.003

(57) ABSTRACT

Provided is a technique for improving the transfer latency of vector register file data when an interrupt is generated. According to an aspect, when interrupt occurs, a core determines whether to store vector register file data currently being executed in a first memory or in a second memory based on whether or not the first memory can store the vector register file data therein. In response to not being able to store the vector register file data in the first memory, a data transfer unit, which is implemented as hardware, is provided to store vector register file data in the second memory.

### CROSS-REFERENCE TO RELATED APPLICATION(S)

This application claims the benefit under 35 USC §119(a) of Korean Patent Application No. 10-2011-0117186, filed on Nov. 10, 2011, in the Korean Intellectual Property Office, the entire disclosure of which is incorporated herein by reference for all purposes.

### BACKGROUND

1. Field

The following description relates to a technique for improving the transfer latency of vector register file data when an interrupt occurs.

2. Description of the Related Art

An interrupt is a signal that causes a core of a computing system to temporarily stop a process from being executed and cause another process to be executed. The core should process the interrupt when the interrupt occurs regardless of whether the interrupt occurs inside or outside of the computing system.

When an interrupt occurs, typically the core of the computing system processes the interrupt through the steps of data saving, interrupt handling, and data restoring.

Data saving is a process in which the core temporarily stops a process from being executed and stores process data of the process currently being executed. During data saving, the core moves data stored in a register file to a memory and stores it therein.

Interrupt handling is a process of jumping to an interrupt processing routine to execute another process. That is, interrupt handling is a process in which the core calls a function capable of processing the interrupt and the core executes the function.

Data restoring is a process of restoring the stored process data and resuming the temporarily stopped process, after the interrupt has been processed. That is, data restoring is a process in which the core returns the data stored in the memory to the register file to restore the data.

Computing systems developed so far generally include a scalar register file consisting of one or more scalar registers and a vector register file consisting of one or more vector registers. When an interrupt is generated, a core typically stores current register file data in a Scratch Pad Memory (SPM) in order to process the interrupt. However, in embedded systems, such as a mobile phone, and the like, there are many instances in which the available storage space of the SPM is insufficient. Accordingly, a problem occurs when vector register file data having a greater capacity than scalar register file data is stored in the SPM.

### SUMMARY

In an aspect, there is provided a core system to improve transfer latency, the core system including a first memory, a second memory comprising a greater storage capacity than the first memory, a vector register file comprising a plurality of vector registers, a core configured to determine whether the first memory is able to store vector register file data that is currently being executed, in response to an interrupt occurring, and to generate a first instruction or a second instruction for storing the vector register file data in the first memory or in the second memory, respectively, based on whether the first memory is able to store the vector register file data, and a data transfer unit configured to read the vector register file data from the vector register file and to store the vector register file data in the second memory, in response to the second instruction being generated by the core.

The core may generate a third instruction or a fourth instruction for restoring the vector register file data stored in the first memory or in the second memory, respectively, in response to processing of the interrupt being completed.

The data transfer unit may read the vector register file data stored in the second memory and transfer the vector register file data to the vector register file to restore the vector register file data, in response to the fourth instruction being generated by the core.

The core may read the vector register file data from the vector register file and store the vector register file data in the first memory, in response to the first instruction being generated by the core.

The core may read the vector register file data stored in the first memory and transfer the vector register file data to the vector register file to restore the vector register file data, in response to the third instruction being generated by the core.

The data transfer unit may comprise a data storage unit configured to read the vector register file data from the vector register file and to store the vector register file data in the second memory, in response to the second instruction being generated by the core, and a data restoring unit configured to read the vector register file data from the second memory and to transfer the vector register file data to the vector register file to restore the vector register file data, in response to the fourth instruction being generated by the core.

The data transfer unit may further comprise a buffer configured to buffer the vector register file data that is to be stored in the second memory by the data storage unit or that is to be read from the second memory by the data restoring unit.

The data transfer unit may further comprise a system bus interface configured to store and to restore the vector register file data through a system bus.

The core may be configured to store and to restore the vector register file data through a data memory controller.

The first memory may comprise a Scratch Pad Memory (SPM) and the second memory may comprise a Synchronous Dynamic Random Access Memory (SDRAM).

The core may comprise a single core or a multi core consisting of two or more cores.

In an aspect, there is provided a method of transferring vector register file data in a core system including a core, a data transfer unit, a first memory, and a second memory, the method including detecting an interrupt, determining whether the first memory is able to store vector register file data that is currently being executed, in response to determining to store the vector register file data in the first memory, storing, by the core, the vector register file data in the first memory, and in response to determining to store the vector register file data in the second memory, storing, by the data transfer unit, the vector register file data in the second memory.

The method may further comprise detecting termination of the interrupt, determining whether the vector register file data has been stored in the first memory or in the second memory, in response to the vector register file data being stored in the first memory, reading, by the core, the vector register file data stored in the first memory and transferring the vector register file data to the vector register file to restore the vector register file data, and in response to the vector register file data being stored in the second memory, reading, by the data transfer unit, the vector register file data stored in the second memory and transferring the vector register file data to the vector register file to restore the vector register file data.

In an aspect, there is provided a processor including a vector register file comprising a plurality of registers configured to store data being processed by the processor, a core configured to suspend processing of a current process in response to an interrupt, and to determine whether to store vector register file data corresponding to the suspended process in a first memory or a second memory, and a data transfer unit configured to read data from the vector register file and transmit the data to the second memory.

In response to the core determining to store the vector register file data corresponding to the suspended process in the first memory, the core may transmit the vector register data to the first memory.

In response to the core determining to store the vector register file data corresponding to the suspended process in the second memory, the core may transmit a notification to the data transfer unit, and the data transfer unit may read the data from the vector register file and transmit the data to the second memory.

The data transfer unit may be hardwarily implemented through a system bus of the processor.

Other features and aspects will be apparent from the following detailed description, the drawings, and the claims.

### BRIEF DESCRIPTION OF THE DRAWINGS

FIG. 1 is a diagram illustrating an example of a core system with improved transfer latency.

FIG. 2 is a diagram illustrating an example of a data transfer unit included in the core system illustrated in FIG. 1.

FIG. 3 is a flowchart illustrating an example of a vector register file data storing method.

FIG. 4 is a flowchart illustrating an example of a vector register file data restoring method.

FIG. 5 is a flowchart illustrating an example of a vector register file data transferring method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the following description, a first memory is a memory to which register file data moves when an interrupt occurs, and a second memory is a memory to which register file data moves when the storage area of the first memory is insufficient or for another desired reason. In various examples, the second memory has relatively greater capacity than the first memory.

According to various aspects, the second memory having greater capacity than the first memory is used to prevent a memory capacity shortage when vector register file data having greater capacity than scalar register file data is stored in the first memory.

For example, if vector register file data is stored in the second memory by a core, a software bottleneck may occur because the second memory is interfaced through the core and system buses. In other words, a stall may occur while vector register file data is stored and restored in the second memory. The stall may increase the transfer latency of the vector register file data, resulting in a reduction of an interrupt processing speed of a core system.

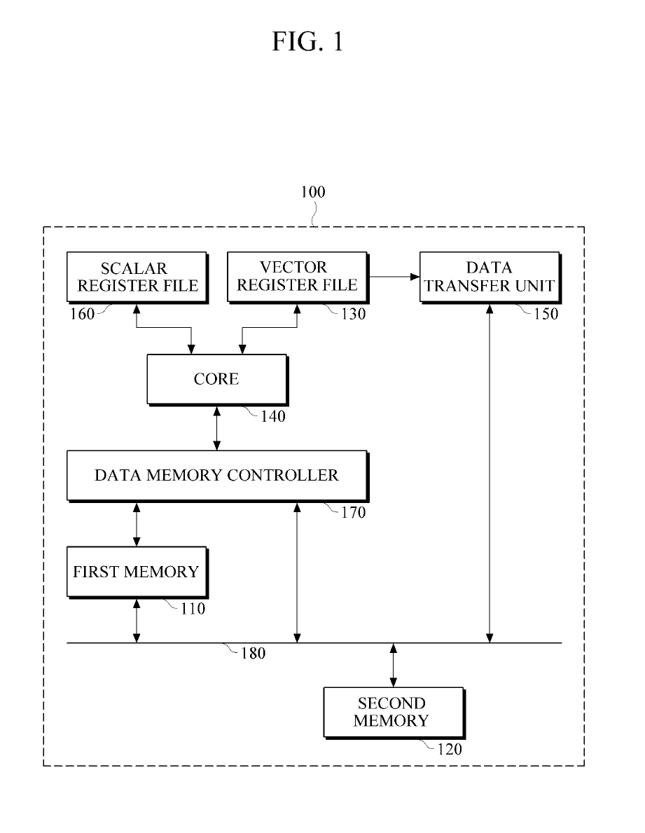

FIG. 1 illustrates an example of a core system 100 with improved transfer latency. Referring to FIG. 1, the core system 100 includes a first memory 110, a second memory 120, a vector register file 130, a core 140, and a data transfer unit 150. The core system may be included in a processor. For example, the processor may be included in a terminal such as a mobile phone, a computer, a tablet, an appliance, a television, and the like.

In response to an interrupt, the first memory 110 may store scalar register file (160) data of a process being currently executed and vector register file (130) data. As an example, the first memory 110 may be a Scratch Pad Memory (SPM).

According to various aspects, the second memory 120 may have a relatively greater capacity than the first memory 110. In response to the interrupt, the second memory 120 may store the vector register file data, instead of the first memory 110. For example, the second memory 120 may store the vector register file data if the available capacity of the first memory 110 is not enough to store the vector register file data. As an example, the second memory 120 may be a Synchronous Dynamic Random Access Memory (SDRAM).

The vector register file 130 is a group consisting of a plurality of vector registers. In this example, the core system 100 includes a scalar register file 160 which is a group of one or more scalar registers and a vector register file 130 which is a group of one or more vector registers.

The core 140 may be a single core or a multi-core consisting of at least two cores. In response to the interrupt, the core 140 may determine whether the first memory 110 can store vector register file data that is currently being executed, and generate a first or second instruction for storing the vector register file data in the first or second memory 110 or 120 based on whether or not the first memory 110 can store the vector register file data therein. For example, if the core 140 determines that the vector register file data can be stored in the first memory 110, the core 140 may generate the first instruction for storing the vector register file data in the first memory 110. As another example, if the core 140 determines the vector register file data cannot be stored in the first memory 110, the core 140 may generate a second instruction for storing the vector register file data in the second memory 120.

An interrupt may be detected by the core 140 sensing an interrupt occurrence event. The core 140 may determine whether or not the first memory 110 can store the vector register file data that is currently being executed by comparison between the amount of the vector register file data and the available capacity of the first memory 110.

If it is determined that the first memory 110 can store the vector register file data therein and accordingly the first instruction is generated, the core 140 reads the vector register file data currently being executed from the vector register file 130 and stores the read vector register file data in the first memory 110. Because the core 140 directly accesses the first memory 110 through a data memory controller 170 to store the vector register file data in the first memory 110, little or no data transfer latency is generated.

The data transfer unit 150 may be implemented as hardware, that is, hardwarily. In response to the core 140 generating the second instruction, the data transfer unit 150 may read the vector register file data currently being executed from the vector register file 130 and store the read vector register file data in the second memory 120. That is, if the second instruction is generated, the core 140 may transfer the second instruction to the data transfer unit 150 to notify that the available capacity of the first memory 110 is insufficient. Accordingly, the data transfer unit 150 may read vector register file data directly and sequentially from the vector register file 130 and store the vector register file data in the second memory 120 according to the second instruction.

If the core 140 softwarily reads vector register file data from the vector register file 130 through a system bus 180 and stores the vector register file data in the second memory 120, a software bottleneck may occur which may increase the transfer latency of the vector register file data.

Due to the characteristics of software and hardware, a certain process can be hardwarily executed at significantly higher rate than when the same process is softwarily executed. In order to use the benefits of software and hardware, the second memory 120 may be connected to the data transfer unit 150 that is hardwarily implemented through the system bus 180, and the data transfer unit 150 may read vector register file data sequentially from the vector register file 130 without causing a stall and store the vector register file data in the second memory 120. In this example, the data transfer unit 150, which is hardwarily implemented, is provided to store the vector register file data in the second memory 120, thereby reducing the transfer latency of the vector register file data in comparison to softwarily processing the transfer of the vector register file data.

That is, because storing of vector register file data in the second memory 120 through the data transfer unit 150 is performed hardwarily and the core 140 checks only the state of the first memory 110, it is possible to improve the transfer latency of vector register file data when the vector register file data is stored and accordingly increase an interrupt processing speed of the core system 100.

In response to the interrupt being processed or otherwise terminated, the core 140 may generate a third or fourth instruction for restoring the vector register file data stored in the first or second memory 110 or 120. For example, termination of the interrupt may be detected when the core 140 senses an interrupt termination event.

If the third instruction is generated, the core 140 may read the vector register file data stored in the first memory 110 and transfer the vector register file data to the vector register file 130 to thereby restore the vector register file data. In this example, the core 140 directly accesses the first memory 110 through the data memory controller 170 to read the vector register file data from the first memory 110 and restore the vector register file data to the vector register file 130, thereby preventing the transfer latency of the vector register file data.

If the fourth instruction is generated, the data transfer unit 150, which is hardwarily implemented, may read the vector register file data stored in the second memory 120, and transfer the vector register file data to the vector register file 140 to restore the vector register file data.

If the core 140 softwarily reads the vector register file data from the second memory 120 through the system bus 180 and restores the vector register file data to the vector register file 130, a software bottleneck may occur and may cause transfer latency of the vector register file data when the vector register file data is restored.

According to various aspects herein, the second memory 120 is connected to the data transfer unit 150 that is hardwarily implemented through the system bus 180. In this example, the data transfer unit 150 may read vector register file data sequentially from the second memory 120 without causing a stall and transfer the vector register file data to the vector register file 130 to restore the vector register file data. In addition, because the data transfer unit 150, which is hardwarily implemented, is used to restore the vector register file data stored in the second memory 120 to the vector register file 130, transfer latency of the vector register file data is reduced in comparison to softwarily processing the data transfer.

According to various aspects, because restoring of vector register file data stored in the second memory 120 is performed by the data transfer unit 150, the core 140 participates only in restoring the vector register filed data stored in the first memory 110. Accordingly, it is possible to improve the transfer latency of the vector register file data when the vector register file data is restored, and thus, increase an interrupt processing speed of the core system 100.

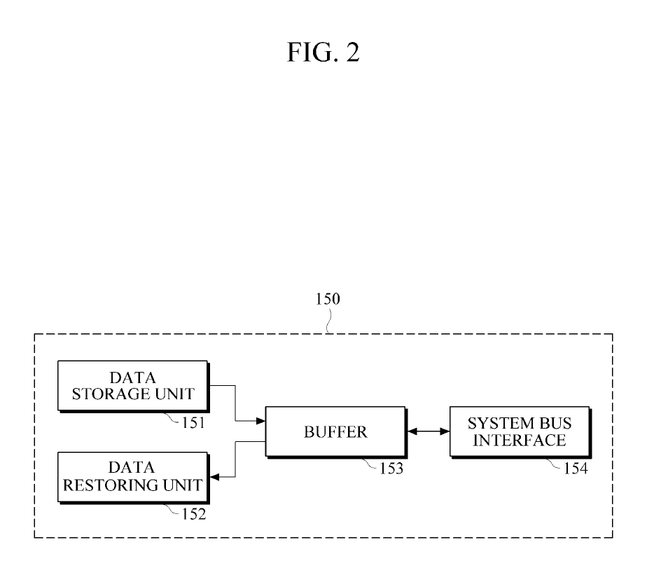

FIG. 2 illustrates an example of the data transfer unit 150 included in the core system 100 illustrated in FIG. 1. Referring to FIG. 2, the data transfer unit 150 includes a data storage unit 151 and a data restoring unit 152.

Referring to FIGS. 1 and 2, in response to receiving the second instruction, the data storage unit 151 may read vector register file data that is currently being executed from the vector register file 130 and store the vector register file data in the second memory 120. When interrupt occurs, the core 140 determines whether or not the first memory 110 can store the vector register file data that is currently being executed, and if the first memory 110 cannot store the vector register file data therein, the core 140 generates the second instruction and transfers the second instruction to the data transfer unit 150 to thereby notify that the available capacity of the first memory 110 is not enough to store the vector register file data.

In response to receiving the second instruction from the core 140, the data transfer unit 150 may read vector register file data sequentially from the data storage unit 151 and store the vector register file data in the second memory 120. Accordingly, because storing of vector register file data in the second memory 120 is performed by the data storage unit 151 of the data transfer unit 150 which is hardwarily implemented, it is possible to reduce the transfer latency of the vector register file data when the vector register file data is stored, and thus, increase an interrupt processing speed of the core system 100.

If the fourth instruction is generated, the data restoring unit 152 may read vector register file data from the second memory 120 and transfer the vector register file data to the vector register file 130 to restore the vector register file data. For example, if the vector register file data is stored in the second memory 120 according to the second instruction for processing of an interrupt, and the interrupt is completed, the core 140 may generate the fourth instruction and transfer the fourth instruction to the data transfer unit 150 for the data transfer unit 150 to restore the vector register file data. In response to receiving the fourth instruction from the core 140, the data transfer unit 150 may read the vector register file data from the second memory 120 through the data restoring unit 152 and transmit the vector register file data to the vector register file 130 to thereby restore the vector register file.

According to various aspects, because restoring of vector register file data stored in the second memory 120 is performed by the data restoring unit 152 of the data transfer unit 150 which is hardwarily implemented, it is possible to improve the transfer latency of the vector register file data when the vector register file data is restored, and thus, increase an interrupt processing speed of the core system 100.

According to another aspect, the data transfer unit 150 may further include a buffer 153. The buffer 153 may buffer vector register file data that is to be stored in the second memory 120 through the data storage unit 151 or that is to be read from the second memory 120 through the data restoring unit 152. That is, by sequentially transferring vector register file data while buffering the vector register file data through the buffer 153 of the data transfer unit 150 when the vector register file data is stored or restored, it is possible to improve the transfer latency of the vector register file data and accordingly increase an interrupt processing speed of the core system 100 (see FIG. 1).

According to another aspect, the data transfer unit 150 may further include a system bus interface 154. The system bus interface 154 is hardware for interfacing with the second memory 120 through a system bus.

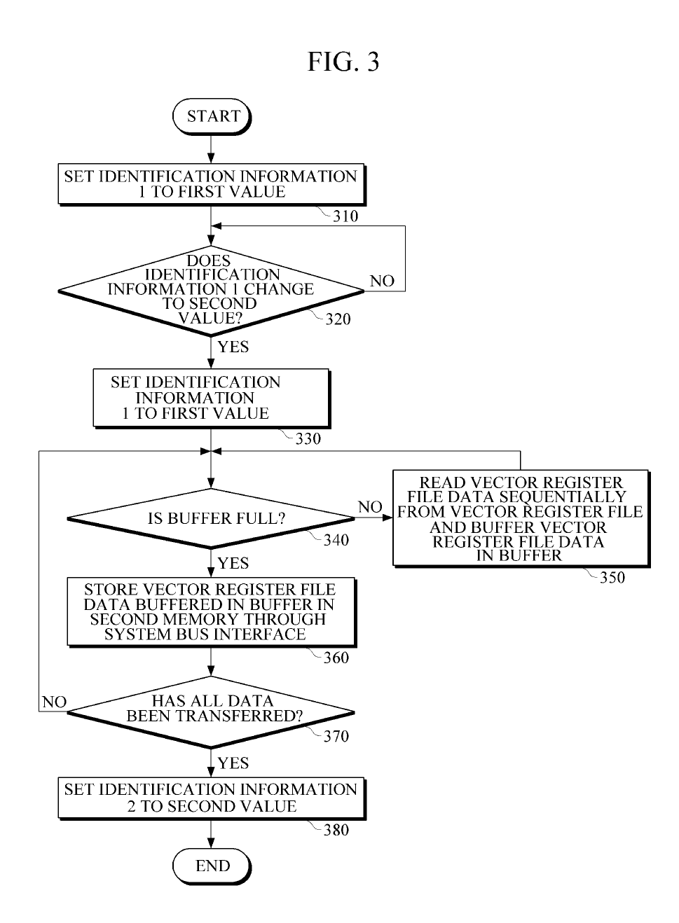

FIG. 3 illustrates an example of a vector register file data storing method which may be performed by the data transfer unit 150 illustrated in FIG. 2. The following description is given with reference to FIGS. 1, 2, and 3. Referring to FIG. 3, identification information 1 for instructing to start storing vector register file data is set to a first value (310).

If the second instruction is generated from the core 140 so that the identification information 1 changes to a second value (320), the data transfer unit 150 again sets the identification information 1 back to the first value (330), and controls the data storage unit 151 to start a procedure of storing the vector register file data.

Before storing the vector register file data, the data storage unit 151 determines whether the buffer 153 is full (340). If the buffer 153 is not full, the data storage unit 151 reads the vector register file data sequentially from the vector register file 130 and buffers the vector register file data therein.

Meanwhile, if the buffer 153 is full, the vector register file data buffered in the buffer 153 is stored in the second memory 120 through the system bus interface 154 (360), and the data storage unit 151 determines whether all vector register file data included in the vector register file 130 has been transferred to the second memory 120 (370). If necessary, the data storage unit 151 repeats operations 340, 350 and 360 until all of the vector register file data is transferred to the second memory 120.

In response to all of the vector register file data included in the vector register file 130 being transferred to the second memory 120 and stored therein, the data transfer unit 150 sets identification information 2 for indicating to store or restore vector register file data to the second value (380). In this example, setting the identification information 2 to the second value represents that vector register file data has been completely stored.

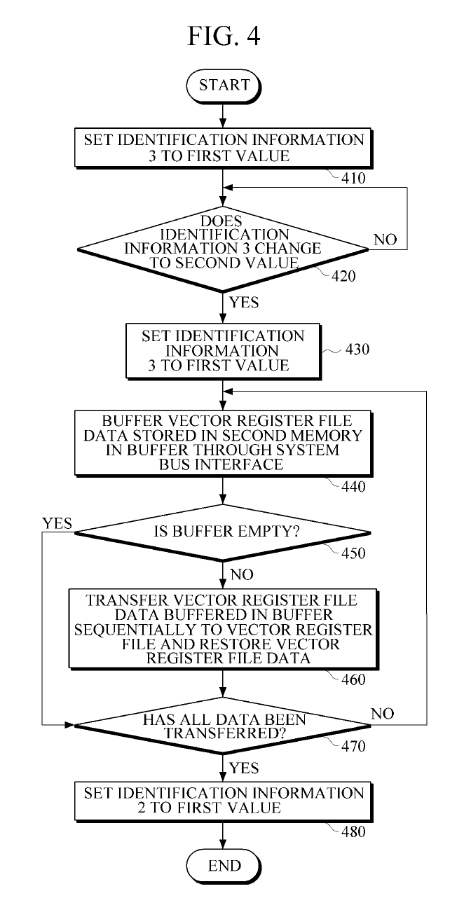

FIG. 4 illustrates an example of a vector register file data restoring method which may be performed by the data transfer unit 150 illustrated in FIG. 2. The following description is given with reference to FIGS. 1, 2, and 4. Referring to FIG. 4, identification information 3 is set to a first value (410). The identification information 3 is used to instruct the data transfer unit 150 to begin restoring vector register file data.

If the fourth instruction is generated from the core 140 such that the identification information 3 changes to a second value (420), the data transfer unit 150 sets the identification information 3 back to the first value (430), and controls the data restoring unit 152 to start restoring the vector register file data.

The vector register file data stored in the second memory 120 is buffered in the buffer 153 through the system bus interface 154 (440), and the data restoring unit 152 determines whether the buffer 153 is empty before restoring the vector register file data (450). If the buffer 153 is not empty, the data restoring unit 152 transfers the vector register file data buffered in the buffer 153 sequentially to the vector register file 130 to restore the vector register file (460).

The data restoring unit 152 determines whether all vector register file data stored in the second memory 120 has been restored (470). If necessary, the data restoring unit 152 repeats operations 440, 450, and 460 until all of the vector register file data stored in the second memory 120 is restored.

When the vector register file data stored in the second memory 120 is restored to the vector register file 130, the data transfer unit 150 sets identification information 2 for indicating to store or restore vector register file data, to the first value (480). In this example, setting the identification information 2 to the first value represents that vector register file data has been completely restored.

As described herein with reference to FIGS. 3 and 4, because vector register file data is stored and restored sequentially through the second memory 120 and the data transfer unit 150 which is hardwarily implemented, it is possible to improve the transfer latency of the vector register file data and increase an interrupt processing speed of the core system 100.

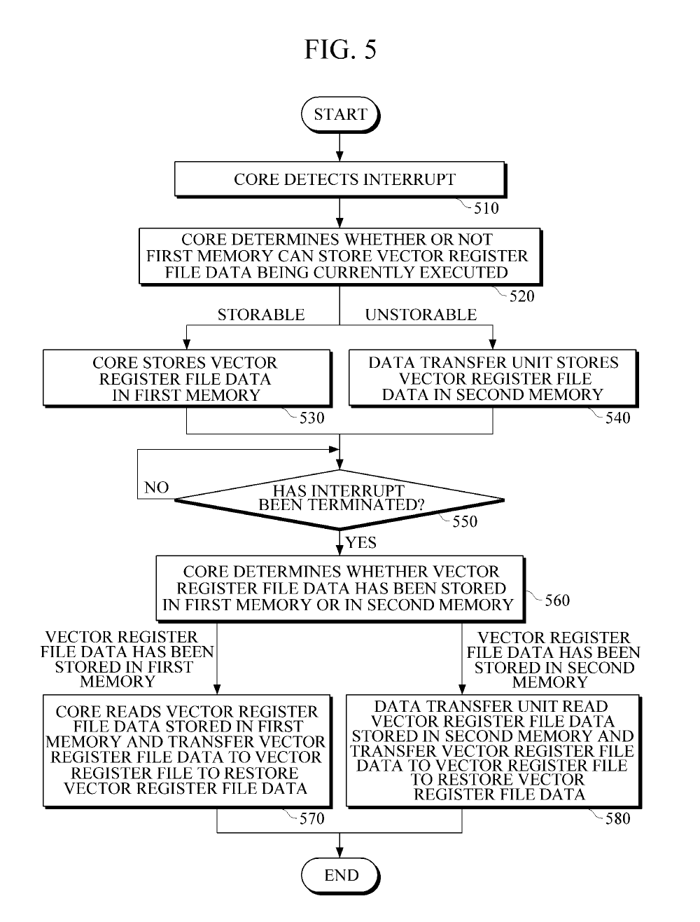

FIG. 5 illustrates an example of a vector register file data transferring method which may be performed by the core system 100 illustrated in FIG. 1. The following description is given with reference to FIGS. 1, 2 and 5.

Referring to FIG. 5, the core 140 detects an occurrence of an interrupt (510). For example, the interrupt may be detected when the core 140 senses an interrupt occurrence event. In response to the interrupt being detected, the core 140 determines whether or not the first memory 110 can store vector register file data being currently executed (520). Determination on whether or not the first memory 110 can store the vector register file data therein may be made by comparing the amount of vector register file data and the available capacity of the first memory 110.

If it is determined in operation 520 that the first memory 110 can store the vector register file data therein, the core 140 stores the vector register file data in the first memory 110 (530). Otherwise, if it is determined in operation 520 that the first memory 110 cannot store the vector register file data therein, the data transfer unit 150 stores the vector register file data in the second memory 120.

After the vector register file data is stored in the first memory 110 or in the second memory 120, the core 140 determines whether the interrupt is terminated (550). For example, termination of the interrupt may be detected when the core 140 senses an interrupt termination event.

If it is determined in operation 550 that the interrupt has been terminated, the core 140 determines whether the vector register file data has been stored in the first memory 110 or in the second memory 120 (560). If the vector register file data has been stored in the first memory 110, the core 140 reads the vector register file data stored in the first memory 110 and transfers the vector register file data to the vector register file 130 to restore the vector register file data (570). Otherwise, if the vector register file data has been stored in the second memory 120, the data transfer unit 150 reads the vector register file data stored in the second memory 120 and transfers the vector register file data to the vector register file 130 to restore the vector register file data (560).

According to various aspects, when an interrupt occurs, the data transfer unit 150 may improve the transfer latency of vector register file data when the vector register file data is stored and restored, resulting in an increase of an interrupt processing speed of the core system 100.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A core system to improve transfer latency, the core system comprising:
a first memory;
a second memory comprising a greater storage capacity than the first memory;
a vector register file comprising a plurality of vector registers;
a core configured to determine whether the first memory is able to store vector register file data that is currently being executed, in response to an interrupt occurring, and to generate a first instruction or a second instruction for storing the vector register file data in the first memory or in the second memory, respectively, based on whether the first memory is able to store the vector register file data; and
a data transfer unit configured to read the vector register file data from the vector register file and to store the vector register file data in the second memory, in response to the second instruction being generated by the core.

2. The core system of claim 1, wherein the core generates a third instruction or a fourth instruction for restoring the vector register file data stored in the first memory or in the second memory, respectively, in response to processing of the interrupt being completed.

3. The core system of claim 2, wherein the data transfer unit reads the vector register file data stored in the second memory and transfers the vector register file data to the vector register file to restore the vector register file data, in response to the fourth instruction being generated by the core.

4. The core system of claim 2, wherein the core reads the vector register file data from the vector register file and stores the vector register file data in the first memory, in response to the first instruction being generated by the core.

5. The core system of claim 4, wherein the core reads the vector register file data stored in the first memory and transfers the vector register file data to the vector register file to restore the vector register file data, in response to the third instruction being generated by the core.

6. The core system of claim 3, wherein the data transfer unit comprises:
a data storage unit configured to read the vector register file data from the vector register file and to store the vector register file data in the second memory, in response to the second instruction being generated by the core; and
a data restoring unit configured to read the vector register file data from the second memory and to transfer the vector register file data to the vector register file to restore the vector register file data, in response to the fourth instruction being generated by the core.

7. The core system of claim 6, wherein the data transfer unit further comprises a buffer configured to buffer the vector register file data that is to be stored in the second memory by the data storage unit or that is to be read from the second memory by the data restoring unit.

8. The core system of claim 7, wherein the data transfer unit further comprises a system bus interface configured to store and to restore the vector register file data through a system bus.

9. The core system of claim 5, wherein the core is configured to store and to restore the vector register file data through a data memory controller.

10. The core system of claim 1, wherein the first memory comprises a Scratch Pad Memory (SPM) and the second memory comprises a Synchronous Dynamic Random Access Memory (SDRAM).

11. The core system of claim 1, wherein the core comprises a single core or a multi core consisting of two or more cores.

12. A method of transferring vector register file data in a core system including a core, a data transfer unit, a first memory, and a second memory, the method comprising:
detecting an interrupt;
determining whether the first memory is able to store vector register file data that is currently being executed;
in response to determining to store the vector register file data in the first memory, storing, by the core, the vector register file data in the first memory; and
in response to determining to store the vector register file data in the second memory, storing, by the data transfer unit, the vector register file data in the second memory.

13. The method of claim 12, further comprising:
detecting termination of the interrupt;
determining whether the vector register file data has been stored in the first memory or in the second memory;
in response to the vector register file data being stored in the first memory, reading, by the core, the vector register file data stored in the first memory and transferring the vector register file data to the vector register file to restore the vector register file data; and
in response to the vector register file data being stored in the second memory, reading, by the data transfer unit, the vector register file data stored in the second memory and transferring the vector register file data to the vector register file to restore the vector register file data.

14. A processor comprising:
a vector register file comprising a plurality of registers configured to store data being processed by the processor;
a core configured to suspend processing of a current process in response to an interrupt, and to determine whether to store vector register file data corresponding to the suspended process in a first memory or a second memory; and
a data transfer unit configured to read data from the vector register file and transmit the data to the second memory.

15. The processor of claim 14, wherein, in response to the core determining to store the vector register file data corresponding to the suspended process in the first memory, the core transmits the vector register data to the first memory.

16. The processor of claim 14, wherein, in response to the core determining to store the vector register file data corresponding to the suspended process in the second memory, the core transmits a notification to the data transfer unit, and the data transfer unit reads the data from the vector register file and transmits the data to the second memory.

17. The processor of claim 14, wherein the data transfer unit is hardwarily implemented through a system bus of the processor.
